(19) United States
(12) Patent Application Publication
(10) Pub. No.: US 2010/0270022 A1
(43) Pub. Date: Oct. 28, 2010

(54) Deep Water Completions Fracturing Fluid Compositions

(75) Inventor: James B. Crews, Willis, TX (US)

Correspondence Address: Mossman, Kumar and Tyler, PC, P.O. Box 421239, Houston, TX, 77242, US

(73) Assignee: Baker Hughes Incorporated, Houston, TX (US)

(21) Appl. No.: 12/830,978

(22) Filed: Jul. 6, 2010

Related U.S. Application Data
(63) Continuation of application No. 11/221,102, filed on Sep. 7, 2005.
Application No. 11/221,102 is a continuation-in-part of application No. 10/280,635, filed on Oct. 25, 2002, now abandoned.
(60) Provisional application No. 60/337,714, filed on Nov. 13, 2001.

(51) Int. Cl. E21B 43/26; C09K 8/68

(52) U.S. Cl. 166/308.3; 507/211; 507/219; 507/217

(57) ABSTRACT

It has been discovered that fracturing fluid compositions can be designed for successful deep water completion fracturing fluid operations. These fluids must be pumped relatively long distances from offshore platforms to the reservoir, and they are often subjected to a wide temperature range. Under these conditions, it is necessary to inhibit the formation of gas hydrates in the fracturing fluid compositions, as well as to delay the crosslinking of the gels that are formed to increase the viscosity of the fluids prior to fracturing the formation. Preferably, two different gas hydrate inhibitors are used to ensure placement of a gas hydrate inhibitor in most parts of the operation. In addition, as with all offshore or deep water hydrocarbon recovery operations, it is important that the components of the fracturing fluid compositions be environmentally benign and biodegradable.

### CROSS-REFERENCE TO RELATED APPLICATIONS

This application is a continuation of U.S. patent application Ser. No. 11/221,102 filed Sep. 7, 2005, which is a continuation-in-part of U.S. patent application Ser. No. 10/280,635 filed Oct. 25, 2002, and claims the benefit of U.S. Provisional Application No. 60/337,714 filed Nov. 13, 2001.

### TECHNICAL FIELD

The present invention relates to fluids and methods used in fracturing subterranean formations during hydrocarbon recovery operations, and more particularly relates, in one embodiment, to fluids and methods of fracturing subterranean formations beneath the sea floor and/or where the well bore encounters a wide temperature range.

### BACKGROUND OF THE INVENTION

Hydraulic fracturing is a method of using pump rate and hydraulic pressure to fracture or crack a subterranean formation. Once the crack or cracks are made, high permeability proppant, relative to the formation permeability, is pumped into the fracture to prop open the crack. When the applied pump rates and pressures are reduced or removed from the formation, the crack or fracture cannot close or heal completely because the high permeability proppant keeps the crack open. The propped crack or fracture provides a high permeability path connecting the producing wellbore to a larger formation area to enhance the production of hydrocarbons.

The development of suitable fracturing fluids is a complex art because the fluids must simultaneously meet a number of conditions. For example, they must be stable at high temperatures and/or high pump rates and shear rates that can cause the fluids to degrade and prematurely settle out the proppant before the fracturing operation is complete. Various fluids have been developed, but most commercially used fracturing fluids are aqueous based liquids that have either been gelled or foamed. When the fluids are gelled, typically a polymeric gelling agent, such as a solvatable polysaccharide is used. The thickened or gelled fluid helps keep the proppants within the fluid. Gelling can be accomplished or improved by the use of crosslinking agents or crosslinkers that promote crosslinking of the polymers together, thereby increasing the viscosity of the fluid.

The recovery of fracturing fluids may be accomplished by reducing the viscosity of the fluid to a low value so that it may flow naturally from the formation under the influence of formation fluids. Crosslinked gels generally require viscosity breakers to be injected to reduce the viscosity or “break” the gel. Enzymes, oxidizers, and acids are known polymer viscosity breakers. Enzymes are effective within a pH range, typically a 2.0 to 10.0 range, with increasing activity as the pH is lowered towards neutral from a pH of 10.0. Most conventional borate crosslinked fracturing fluids and breakers are designed from a fixed high crosslinked fluid pH value at ambient temperature and/or reservoir temperature. Optimizing the pH for a borate crosslinked gel is important to achieve proper crosslink stability and controlled enzyme breaker activity.

One difficulty with conventional fracturing fluids is the fact that they tend to emulsify when they come into contact with crude oil, which inhibits the ability to pump them further down hole to the subterranean formation, and/or increases the energy requirements of the pumping operation, in turn raising costs. Various additives are incorporated into fracturing fluids as non-emulsifiers or emulsifier inhibitors and specific examples include, but are not necessarily limited to ethoxylated alkyl phenols, alkyl benzyl sulfonates, xylene sulfonates, alkyloxylated surfactants, ethoxylated alcohols, surfactants and resins, and phosphate esters. Further, certain additives are known which, by themselves, do not act as emulsifiers, but instead enhance the performance of the non-emulsifiers. Various non-emulsifier enhancers include, but are not necessarily limited to alcohol, glycol ethers, polyglycols, aminocarboxylic acids and their salts, bisulfites, polyaspartates, aromatics and mixtures thereof.

Fracturing fluids also include additives to help inhibit the formation of scale including, but not necessarily limited to carbonate scales and sulfate scales. Such scale cause blockages not only in the equipment used in hydrocarbon recovery, but also can create fines that block the pores of the subterranean formation. Examples of scale inhibitors and/or scale removers incorporated into fracturing fluids include, but are not necessarily limited to polyaspartates; hydroxyaminocarboxylic acid (HACA) chelating agents, such as hydroxyethyliminodiacetic acid (HEIDA); ethylenediaminetetracetic acid (EDTA), diethylenetriaminepentaacetic acid (DTPA), nitrilotriacetic acid (NTA) and other carboxylic acids and their salt forms, phosphonates, and acrylates and mixtures thereof.

Fracturing fluids that are crosslinked with titanate, zirconate, and/or borate ions (using compounds which generate these ions), sometimes contain additives that are designed to delay crosslinking. Crosslinking delay agents permit the fracturing to be pumped down hole to the subterranean formation before crosslinking begins to occur, thereby permitting more versatility or flexibility in the fracturing fluid. Examples of crosslink delay agents commonly incorporated into fracturing fluids include, but are not necessarily limited to organic polyols, such as sodium gluconate; sodium glucoheptonate, sorbitol, glyoxal, mannitol, glucose, fructose, alkyl glucosides, phosphonates, aminocarboxylic acids and their salts (EDTA, DTPA, etc.) and mixtures thereof.

Other common additives employed in conventional fracturing fluids include crosslinked gel stabilizers that stabilize the crosslinked gel (typically a polysaccharide crosslinked with titanate, zirconate or borate) for a sufficient period of time so that the pump rate and hydraulic pressure may fracture the subterranean formations. Suitable crosslinked gel stabilizers previously used include, but are not necessarily limited to, sodium thiosulfate, diethanolamine, triethanolamine, methanol, hydroxyethylglycine, tetraethylenepentamine, ethylenediamine and mixtures thereof.

Additional common additives for fracturing fluids are enzyme breaker (protein) stabilizers. These compounds stabilize the enzymes and/or proteins used in the fracturing fluids to eventually break the gel after the subterranean formation is fractured so that they are still effective at the time it is desired to break the gel. If the enzymes degrade too early they will not be available to effectively break the gel at the appropriate time. Examples of enzyme breaker stabilizers commonly incorporated into fracturing fluids include, but are not necessarily limited to sorbitol, mannitol, glycerol, sulfites, citrates, aminocarboxylic acids and their salts (EDTA, DTPA, NTA, etc.), phosphonates, sulphonates and mixtures thereof.

Further, many of the common additives previously used discussed above present environmental concerns because many are toxic to land and marine life and many are not readily biodegradable when it becomes necessary to dispose of the fracturing fluid. Low toxicity and biodegradability of the particular components of a fracturing fluid is particularly important when the fluid is used on an offshore platform and the spent fracturing fluid is disposed of into the sea or the fracturing fluid incidentally leaks into the sea during the fracturing operation. Such components are sometimes termed “green” chemistry to denote products that have low toxicity, are biodegradable, and do not bio-accumulate within organisms in land or marine water environments, and/or the components decompose to products that are environmentally benign.

Other concerns about fracturing operations offshore include the facts that water depths can be up to 12,000 feet (3,660 m) with sea floor temperatures as low as 25° F. (−4.0° C.). The reservoir to be fractured can be a total of more than 25,000 feet (7,620 m) from the completion platform. The production reservoir or formation may be at temperatures above 350° F. (177° C.). Many wellbores and associated subsea production pipelines are prone to gas hydrate precipitation and subsequent plugging.

It would be desirable if multifunctional fracturing fluid compositions could be devised that have suitable properties or characteristics for deep water (offshore platform) fracturing fluids using low toxicity and biodegradable additives and compounds, and that also inhibit gas hydrates and are operable over a wide temperature range.

### SUMMARY

Accordingly, it is an object of the present invention to provide multifunctional fracturing fluids that can be used in deep water fracturing operations.

It is another object of the present invention to provide a low toxicity and biodegradable fracturing fluid composition that is inhibited against gas hydrate formation.

Another object of the present invention to provide a fracturing fluid composition with specialized crosslink delay ability that is operable over a wide temperature range; in one non-limiting embodiment, a difference of about 200° F. (93° C.) or more.

In carrying out these and other objects of the invention, there is provided, in one form, a method for fracturing a subterranean formation that includes, but is not necessarily limited to:
a. pumping a fracturing fluid composition down a wellbore to a subterranean formation;
b. permitting the fracturing fluid composition to gel;
c. pumping the fracturing fluid composition against the subterranean formation at sufficient rate and pressure to fracture the formation;
d. breaking the fracturing fluid composition gel; and
e. subsequently flowing the fracturing fluid composition out of the formation.

A fracturing fluid composition useful in such a method includes, but is not necessarily limited to:

i) water;

ii) at least one hydratable polymer;

iii) at least one crosslinking agent;

iv) at least one crosslinking delay agent;

v) at least one breaking agent; and

vi) at least one gas hydrate inhibitor.

Optionally, there may be vii) an additional gas hydrate inhibitor different from vi), where one of the gas hydrate inhibitors remains in the aqueous phase and the other gas hydrate inhibitor is a polymer that at least temporarily becomes part of a polymer accumulation.

Other components may also be present in the fracturing fluid including, but not necessarily limited to, pH buffers, biocides, surfactants, non-emulsifiers, anti-foamers, additional breaking agents such as enzyme breakers and oxidizer breakers, inorganic scale inhibitors, colorants, clay control agents, gel breaker aids, and mixtures thereof.

### BRIEF DESCRIPTION OF THE DRAWINGS

FIG. 1 is a graph of borate particle crosslinker crosslink delay rate at 75° F. (24° C.) measured as viscosity as a function of time using various proportions of two different types of crosslink delay chemistry;

FIG. 2 is a graph of borate particle crosslinker crosslink delay rate at 40° F. (4° C.) measured as viscosity as a function of time using various proportions of two different types of crosslink delay chemistry;

FIG. 3 is a graph of crosslink delay rate at 75° F. (24° C.) measured as viscosity as a function of time using borate-polyol complex crosslink delay agent chemistry;

FIG. 4 is a graph of crosslink delay rate at 40° F. (4.4° C.) measured as viscosity as a function of time using borate-polyol complex crosslink delay agent chemistry;

FIG. 5 is a chart of chart of the temperature effect on crosslinking rate at the 10 minute delay time for FIGS. 1-4, respectively, to compare the systems; and

FIG. 6 is a graph of borate concentration as a function of pH to show that increases in pH converts the available boron to usable borate ion form.

FIG. 7 is a graph of gas hydrate formation as a function of no gas hydrate inhibitor present within the environmentally green fracturing fluid at 40° F. (4.4° C.) and at 1000 psi;

FIG. 8 is a graph of gas hydrate formation as a function of 1.0% bw INHIBEX 101 gas hydrate inhibitor present within the environmentally green fracturing fluid at 40° F. (4.4° C.) and at 1000 psi (7 MPa);

FIG. 9 is a graph of gas hydrate formation as a function of 2.0% bw INHIBEX 101 gas hydrate inhibitor present within the environmentally green fracturing fluid at 40° F. (4.4° C.) and at 1000 psi (7 MPa);

FIG. 10 is a graph of gas hydrate formation as a function of 1.0% bw GAFFIX 713 gas hydrate inhibitor present within the environmentally green fracturing fluid at 40° F. (4.4° C.) and at 1000 psi (7 MPa);

FIG. 11 is a graph of gas hydrate formation as a function of 2.0% bw GAFFIX 713 gas hydrate inhibitor present within the environmentally green fracturing fluid at 40° F. (4.4° C.) and at 1000 psi (7 MPa);

FIG. 12 is a graph of gas hydrate formation as a function of 1.0% bw XTJ-504 (triethyleneglycoldiamine) gas hydrate inhibitor present within the environmentally green fracturing fluid at 40° F. (4.4° C.) and at 1000 psi (7 MPa);

FIG. 13 is a graph of gas hydrate formation as a function of 2.0% bw XTJ-504 gas hydrate inhibitor present within the environmentally green fracturing fluid at 40° F. (4.4° C.) and at 1000 psi (7 MPa);

FIG. 14 is a graph of gas hydrate formation as a function of 2.0% bw INHIBEX® 101 gas hydrate inhibitor present within the environmentally green fracturing fluid at 40° F. (4.4° C.) and at 1500 psi (10 MPa);

FIG. 15 is a graph of gas hydrate formation as a function of 2.0% bw GAFFIX® 713 gas hydrate inhibitor present within the environmentally green fracturing fluid at 40° F. (4.4° C.) and at 1500 psi (10 MPa);

FIG. 16 is a graph of pressure verses temperature gas hydrate phase equilibrium curves for various amounts of methanol gas hydrate inhibitor in fresh water;

FIG. 17 is a graph of pressure verses temperature gas hydrate phase equilibrium curves for various amounts of ethylene glycol gas hydrate inhibitor in fresh water;

FIG. 18 is a graph of pressure verses temperature gas hydrate phase equilibrium curves for various amounts of NaCl gas hydrate inhibitor in fresh water;

FIG. 19 is a graph of pressure verses temperature gas hydrate phase equilibrium curves for various amounts of KCl gas hydrate inhibitor in fresh water;

FIG. 20 is a graph of pressure verses temperature gas hydrate phase equilibrium curves for various amounts of CaCl₂ gas hydrate inhibitor in fresh water;

FIG. 21 is a graph of pressure verses temperature gas hydrate phase equilibrium curves for various amounts of potassium formate gas hydrate inhibitor in fresh water;

FIG. 22 is a graph of pressure verses temperature gas hydrate phase equilibrium curves for various amounts of ethylene glycol with 2% bw KCl gas hydrate inhibitors in fresh water;

FIG. 23 is a graph of pressure verses temperature gas hydrate phase equilibrium curves for various amounts of NaCl and ethylene glycol with 2% bw KCl gas hydrate inhibitors in fresh water; and

FIG. 24 is a graph of pressure verses temperature gas hydrate phase equilibrium curves for various amounts of Ethylene glycol with 20% bw NaCl and 2% bw KCl gas hydrate inhibitors in fresh water.

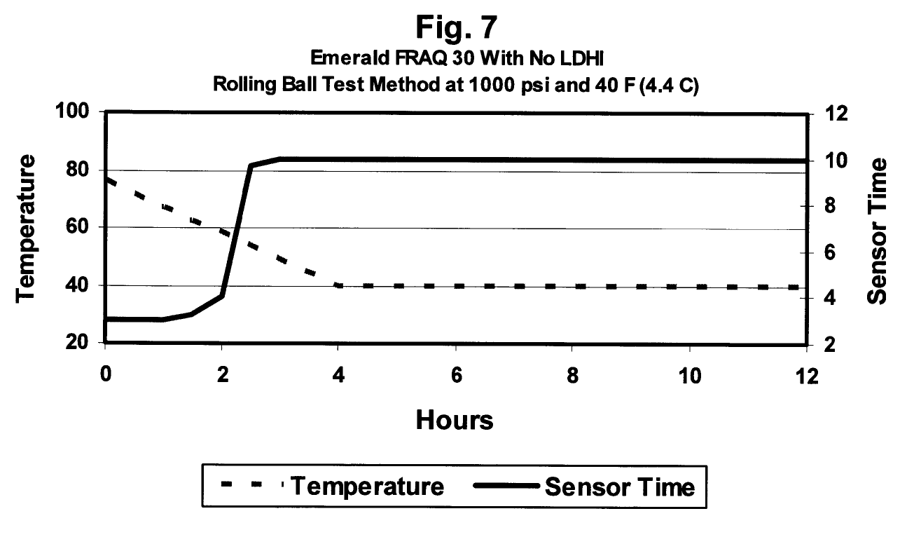

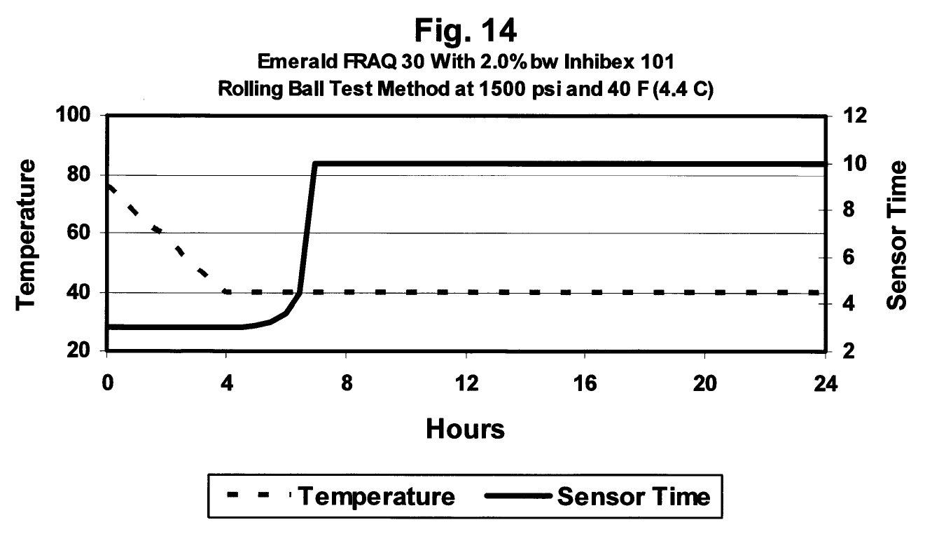

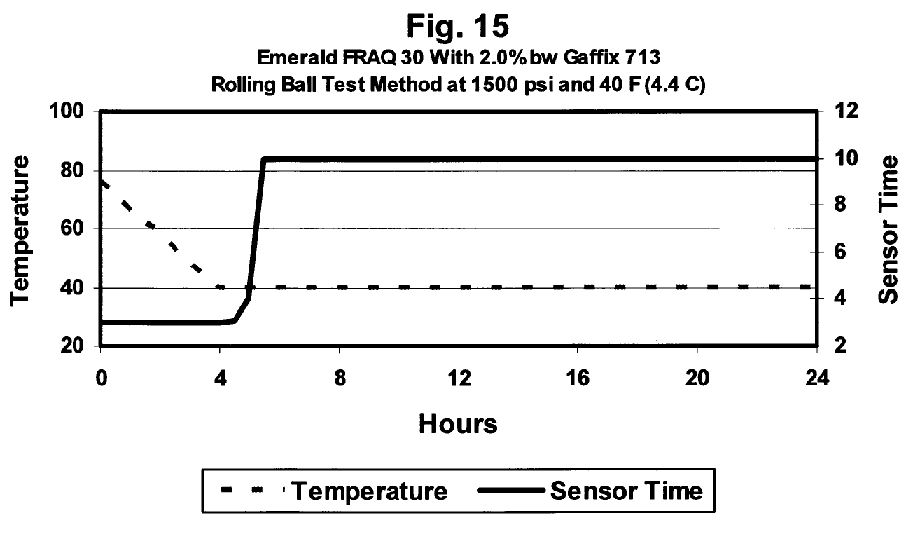

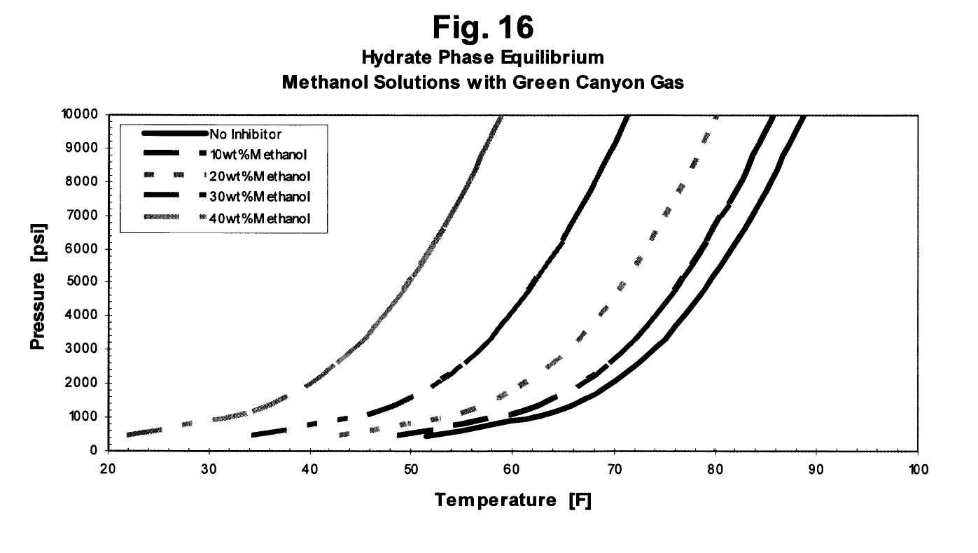

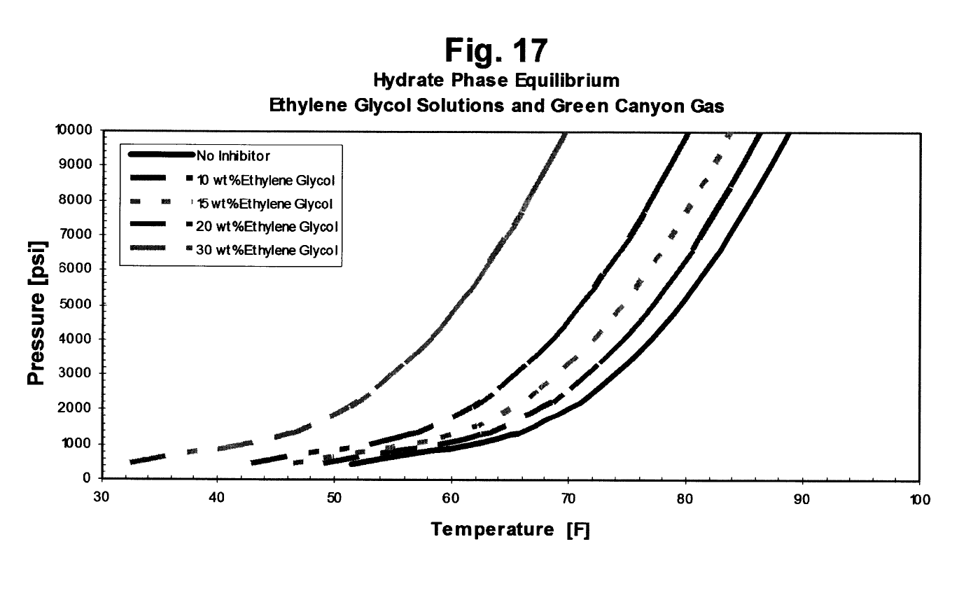

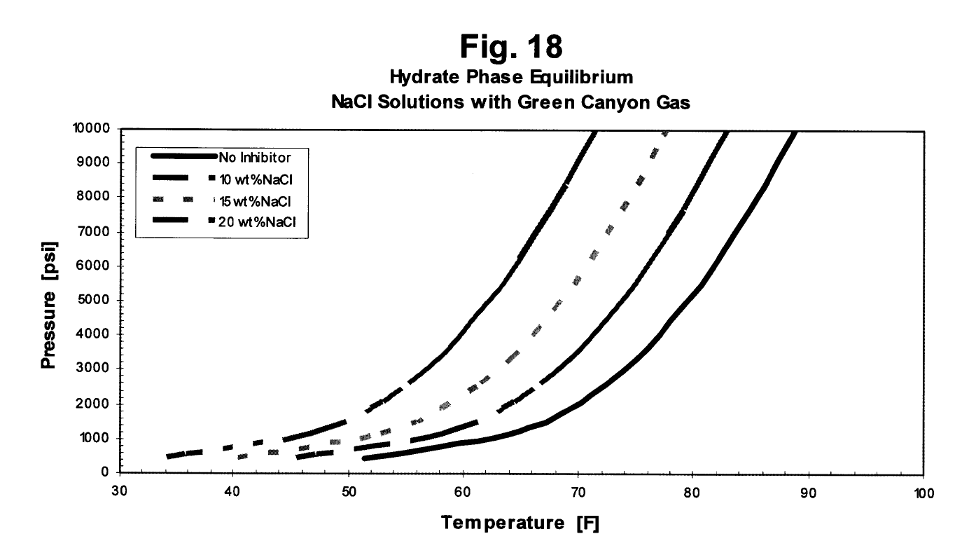

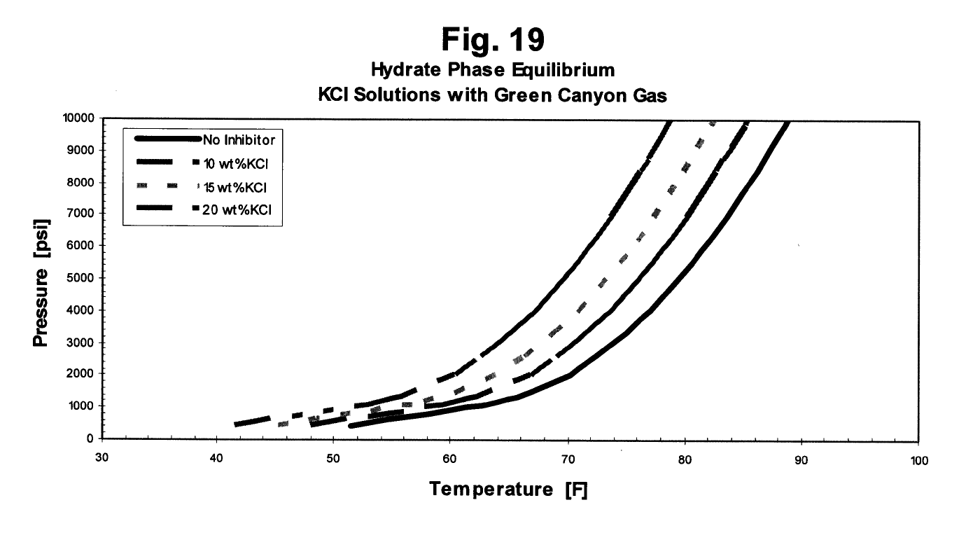

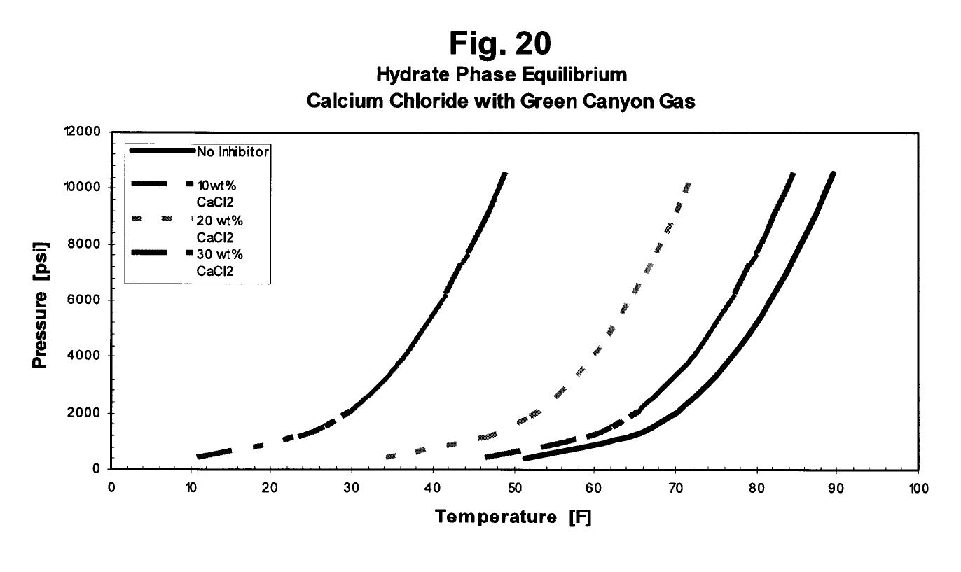

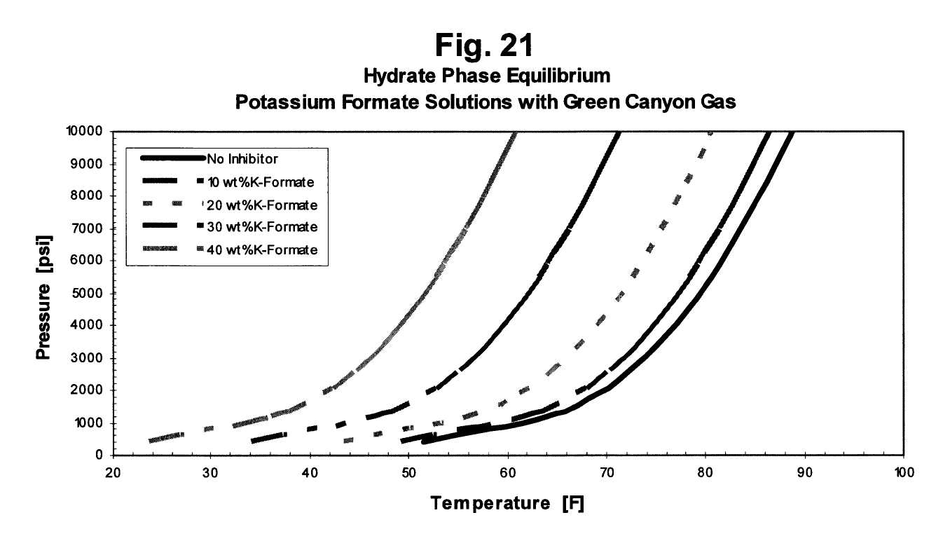

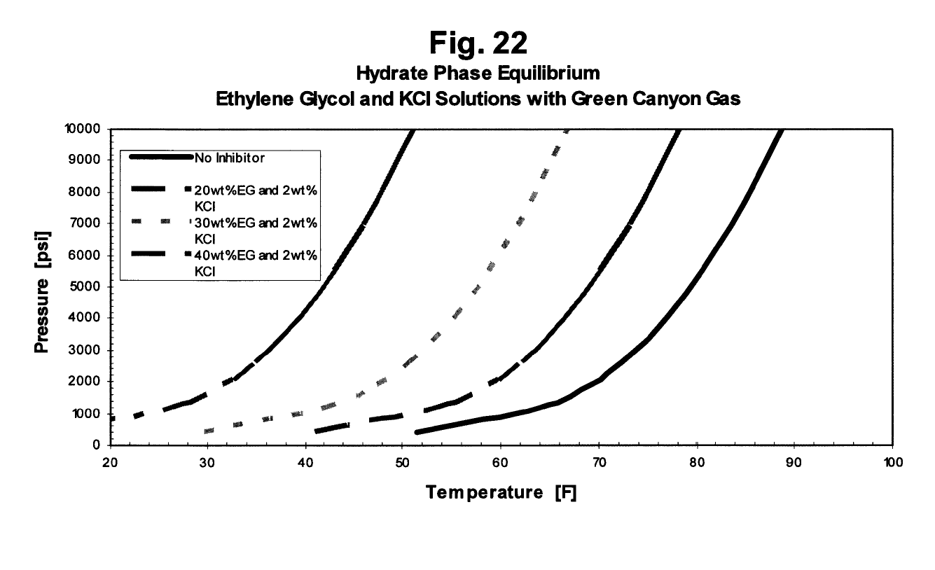

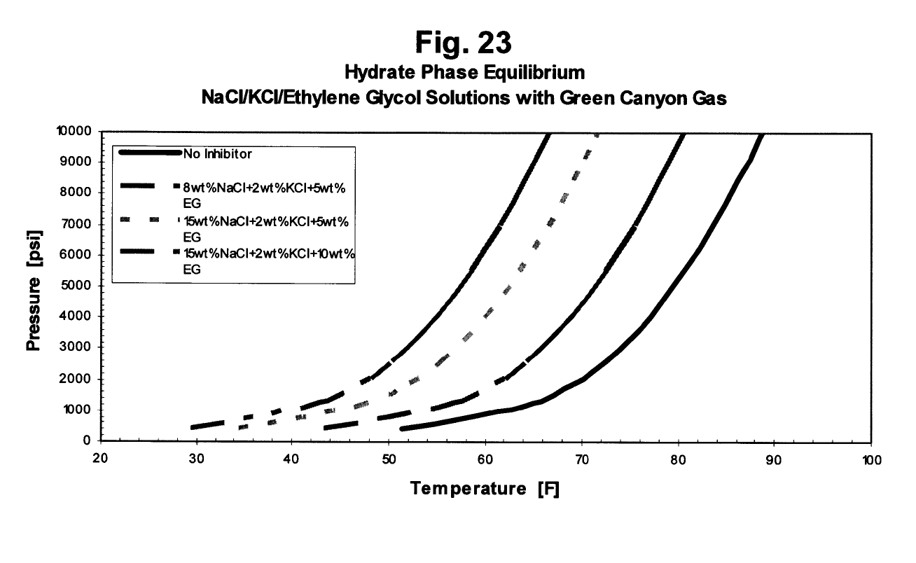

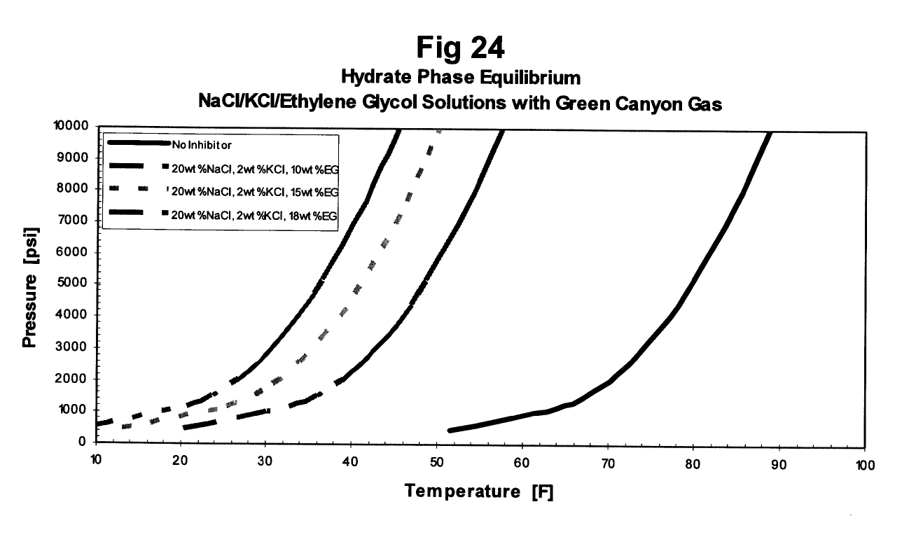

FIGS. 7-15 are plots resulting from LDHI tests performed using a pressurized rocking-arm rolling-ball gas hydrate test method and instrumentation. The data from FIGS. 16 to 24 are thermodynamic inhibitor gas hydrate phase equilibrium curve calculations made using industry recognized prediction software.

### DETAILED DESCRIPTION

Deep water completions are commonly “frac packed”. Water depths for these off shore operations can be up to 12,000 feet (3,660 m) deep with sea floor water temperatures as low as 25° F. (−4.0° C.). In contrast, the production reservoir can be at temperatures up to about 350° F. (about 177° C.). Additionally, the reservoir to be fractured can be at a total distance of more than 25,000 feet (7,620 m) from the completion platform (extended reach completions). Many wellbores and associated subsea production pipelines are prone to gas hydrate precipitation and plugging as the gas hydrate forming species and water are transported through environments of different temperature and pressure from their origin. Gas hydrates are also a problem on land and in shallower marine waters when the gas reservoirs are very deep, such as greater that 15,000 ft (4,570 m) of rock or sediment to the reservoir. As noted, offshore environments often necessitate “green chemistry” chemical products that are benign (have low toxicity) and/or have readily biodegradable components. Novel fracturing fluid compositions have been discovered which will successfully frac pack deep water and other types of subsea completions, as well as any formation fracturing operation where there is a relatively wide temperature range over the length of the wellbore and/or the total wellbore length from the platform to the reservoir is relatively long. In other words, a fracturing fluid composition is provided that can be varied or modified to meet deep water and other subsea frac pack applications.

The fracturing fluid composition of this invention generally has the following composition:
i) water;
ii) at least one hydratable polymer;
iii) at least one crosslinking agent;
iv) at least one crosslinking delay agent;
v) at least one breaking agent;
vi) at least one gas hydrate inhibitor; and
vii) optionally a second gas hydrate inhibitor, where one of the hydrate inhibitors has the ability or characteristic to stay in the aqueous solution phase (e.g. surfactants, alcohols, solvents, salts, etc.) and the other is a polymer (e.g. HEC, INHIBEX 101, etc.)

In various non-limiting embodiments of the invention, the broad and preferred proportions of these various components may be as shown in Table 1.

TABLE 1
Broad and Narrow Proportions of Fracturing Fluid Components

| Component | Broad Proportions | Preferred Proportions |
|---|---|---|
| Water | about 70 to 99 vol % | about 95 to 99.5 vol % |
| Hydratable polymer | about 10 to 60 pptg (kg/m³) | about 20 to 40 pptg (kg/m³) |
| Crosslinking agent (may optionally | about 0.025 to 3.0 vol % | about 0.04 to 2.0 vol % |
| function also to delay crosslinking) | | |
| Crosslinking delay agent | about 0.006 to 0.5% bw % | about 0.012 to 0.12% bw % |
| Breaking agent | about 0.1 to 40 pptg (kg/m³) | about 0.5 to 20 pptg (kg/m³) |
| Thermodynamic gas hydrate inhibi- | about 0.006, alternatively | about 2.0 to 40.0% bw % |
| tor(s) | 0.5 to 60% bw % | |
| Low dosage hydrate inhibitor(s)* | about 0.005 to 4.0% bw % | about 0.1 to 2.0% bw % |

*Low dosage hydrate inhibitors are a common term for kinetic and anti-agglomerate type gas hydrate inhibitors

The hydratable polymer may be generally any hydratable polymer known to be used to gel or viscosify a fracturing fluid. In one non-limiting embodiment of the invention, the hydratable polymer is a polysaccharide. In another non-limiting embodiment of the invention, the suitable hydratable polymers include, but are not necessarily limited to, glycol- or glycol ether-based slurry guars, hydroxypropyl guar, carboxymethylhydroxypropyl guar or other guar polymer derivatives.

In a preferred embodiment of the invention, the hydratable polymer is crosslinked to provide an even greater viscosity or a tighter gel. Any of the common crosslinking agents may be used including, but not necessarily limited to titanate ion, zirconate ion and borate ion. In one non-limiting embodiment of the invention, the preferred crosslinker is borate ion. Borate ion, as well as the other ions, can be generated from a wide variety of sources.

Because of the wellbore distances involved in deep water completion operations, it is necessary to use crosslink delay additives. For instance, in many deep water operations, it may take from about 1,000 to 12,000 feet (about 305 to 3,660 m) or more of pipe-casing simply to reach the sea floor, in addition to the remaining pipe-casing length to reach the reservoir, which may result in a total pipe length of 25,000 feet (7,620 m) or more. It is important that the polymer gel does not substantially crosslink during this distance en route, but that most crosslinking is delayed until the fracturing fluid has reached or just prior to reaching the formation. Additionally, the crosslink delay additives (as well as all other additives) must be able to perform over the temperature differential expected over the length of the well bore. Such temperature differentials are expected to be about 350° F. (about 194° C.) in one non-limiting embodiment, preferably about 250° F. (about 139° C.), more preferably about 160° F. (about 88° C.), and most preferably about 90° F. (50° C.). The crosslink delay agent should function over a temperature range of from about 350° F. to 25° F. (about 177° C. to −4.0° C.). Crosslink delay additives are also important for deep gas wells (>15,000 ft reservoir depth (4.6 km)) that are located on land or water depths to about 1000 ft (305 m).

It is further helpful in some non-limiting embodiments for the compositions and methods herein to prevent or inhibit gas hydrate formation at relatively high pressures, such as above about 1000 psi (6.9 MPa), alternatively 1500 psi (10 MPa) and in another non-restrictive version above about 2000 psi (14 MPa). An upper limit for these pressures may be about 5000 psi (34 MPa), alternatively about 8,000 psi (55 MPa) and in another embodiment 10,000 psi (69 MPa). Additionally since gas hydrates typically form at increased pressure under reduced temperature, the above-noted pressure ranges may be at temperatures of about 60° F. (16° C.) or below and alternatively at about 40° F. (4.4° C.) or below. Suitable lower limits for these reduced temperature ranges may be about 10° F. (−12° C.), alternatively about 20° F. (−7° C.) in another non-limiting embodiment. The duration at a given temperature and pressure is preferably more than 24 hours, and alternatively more that 72 hours, and in another non-limiting embodiment more than 144 hours before gas hydrate crystals form and/or agglomeration occur that induce wellbore blockage. In one non-limiting embodiment, there is little or no crude oil present under these conditions, but hydrocarbons, e.g. natural gas, or one or more of the components found in Green Canyon Gas of Table 2 may be present.

TABLE 2
Composition of Green Canyon Gas

| Compound | Mole % |
|---|---|
| Methane | 87.200 |
| Nitrogen | 0.400 |
| Ethane | 7.580 |
| Propane | 3.090 |
| Isobutane | 0.496 |
| N-Butane | 0.792 |
| Isopentane | 0.203 |
| N-Pentane | 0.200 |
| Ethylene (as impurity) | 167 ppm |

Suitable crosslinking delay agents include, but are not necessarily limited to, slurried borax suspension (commonly used in a 1.0 to 2.5 gptg¹ application range, available as XL-3L from Baker Oil Tools), ulexite, colemanite, and other slow dissolving crosslinking borate minerals, and complexes of borate ion, zirconate ion, and titanate ion with sorbitol, mannitol, sodium gluconate, sodium glucoheptonate, glycerol, alpha D-glucose, fructose, ribose; alkyl glucosides (such as AG-6202 available from Akzo Nobel), and other ion complexing polyols; and mixtures thereof. A slurried ulexite suspension known as XL-2LW is available from Baker Oil Tools and is commonly used at an application level of about 0.5 to about 3.0 gptg. ¹gptg=gallons per thousand gallons. The same numerical values can be expressed as liters per thousand liters, m³ per thousand m³, etc.

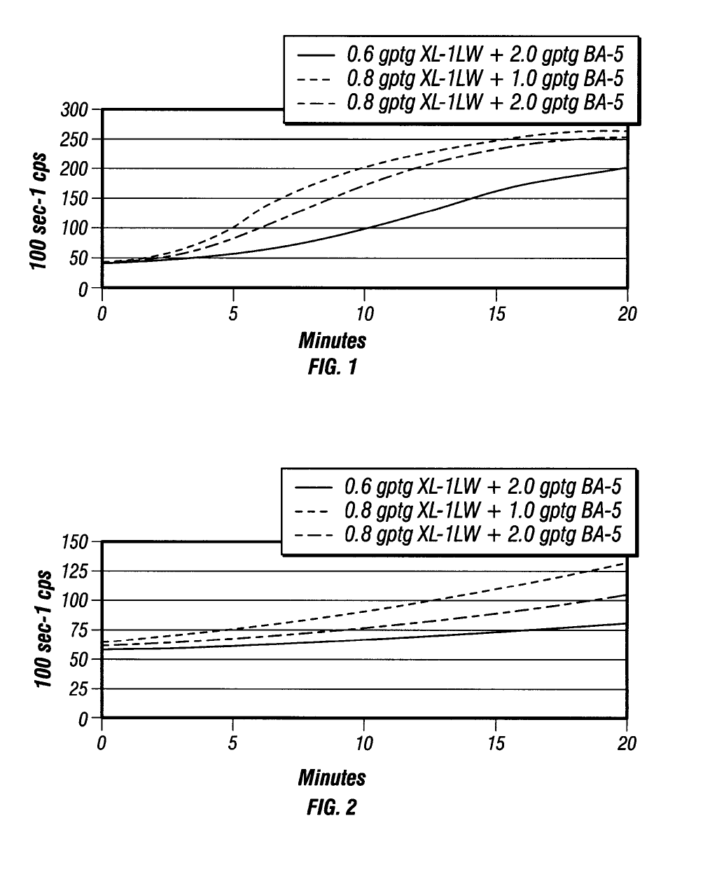

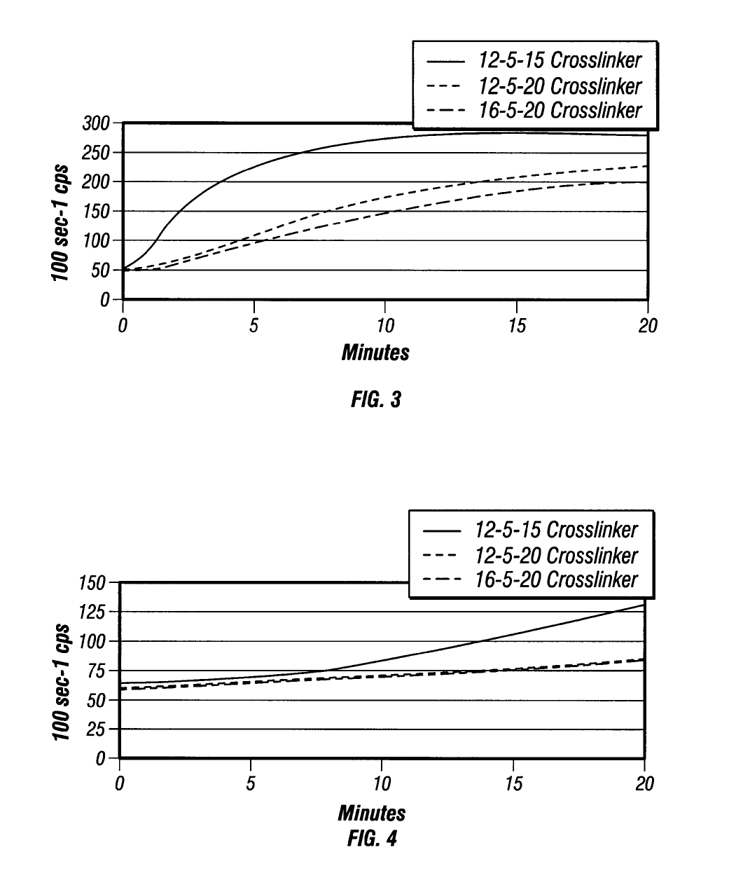

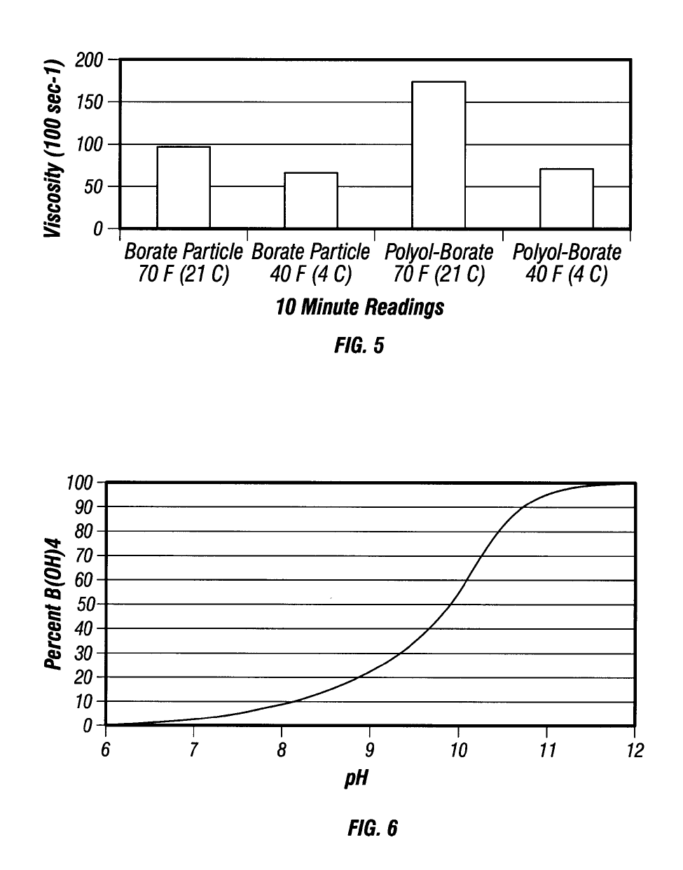

FIGS. 1 to 5 show the <75° F. (<24° C.) temperature crosslinking rate of two types of crosslink delay chemistry, that is, how cooling a fluid can change the crosslink delay rate. FIGS. 1 and 2 present borate mineral particles crosslink delay agent chemistry at 75° F. (24° C.) and 40° F. (4° C.) (note that the XL-1 LW is a slurried ulexite particles crosslinker suspension and the BA-5 is a 47% potassium carbonate pH buffer solution). FIGS. 3 and 4 present borate-polyol complex crosslink delay agent chemistry for 75° F. (24° C.) and 40° F. (4° C.) (note that the 12-5-15 represents 12 pptg sodium hydroxide, 5.0 pptg boric acid, and 15 to 20 pptg sodium gluconate polyol). The FIGS. show what the effect of cooling a delayed fracturing fluid down from 75° F. to 40° F. (24° C. to 4° C.) can do to the rate of crosslinking. FIG. 5 shows the 10-minute delay time viscosity to compare the systems. The data shows the borate mineral chemistry can best be delayed by using minimal crosslinker loading and a raise in pH to convert the boron available to a borate form rather than boric acid (see FIG. 6 for the effect pH has on boric acid-borate ion equilibrium). The borate-polyol chemistry can be best controlled for lower temperature by adjustment of the polyol concentration.

Just as many hydratable polymers and crosslinkers for them are known in the art, there are a wide variety of known gel breakers that would be suitable for use in the methods of this invention. Enzyme breakers that are suitable for use with the present invention include, but are not limited to GAMMANASE 1.0L available from Novozymes, PLEXGEL 10L available from Chemplex, GBW-174L available from Genencor (Bio-Cat distributor), GBW-319 available from Genencor (Bio-Cat distributor), VISCOZYME available from Novozymes, HC-70 available from ChemGen, and mixtures thereof. Oxidizer breakers include, but are not necessarily limited to, chlorites, hypochlorites, bromates, chlorates, percarbonates, peroxides, periodates, persulfates, and mixtures thereof.

Known gas hydrate inhibitors have been used in produced hydrocarbons. There are three general categories of gas hydrate inhibitors: thermodynamic inhibitors (THI), kinetic inhibitors (KHI), and anti-agglomerate inhibitors (AAHI). The kinetic and anti-agglomerate inhibitors are commonly referred to in literature as low dosage hydrate inhibitors (LDHI). Thermodynamic inhibitors (e.g. alcohols, glycols, electrolytes, etc.) lower the chemical potential of water and the hydrogen bond energy, which requires additional cooling before hydrates will begin to form, analogous to antifreeze. These inhibitors will also reduce hydrate stability. The LDHI (kinetic and anti-agglomerate hydrate inhibitors) do not lower the onset temperature of hydrate formation, but they adsorb on the surface of hydrate microcrystals and significantly alter surface tension at the interface between the hydrate-forming phases. These inhibitors prevent a further increase in crystal size and retard formation of large hydrate agglomerates and solid plugs for a period of time. Typically kinetic and anti-agglomerate inhibitors can have the effect of delaying the freezing or disrupting the size of gas hydrate mass to prevent wellbore, pipelines, and other locations from gas hydrate blockage over an extended period of time. In most cases, at temperatures below about 50° F. (about 10° C.) LDHI will prevent gas hydrate mass plugging and wellbore or pipeline blockage for only a specific period of time, such as 14 hours of gas hydrate prevention time for a given wellbore or pipeline temperature and pressure. Typically the cooler the temperature and the greater the pressure the less effective the LDHI will be. Of particular importance, current LDHI products which do not have a crude oil phase present with the gas and aqueous phases are very pressure sensitive, in one non-limiting embodiment working at lower pressures at cooler temperatures, such as less than 1500 psi (10 MPa) and above 40° F. (4.4° C.). Also, most all LDHI reach their maximum effectiveness to prevent gas hydrates at about 2.0% bw concentration, and adding more is often counter-productive. Thermodynamic GHI work well at higher pressures and lower temperature, but the amount of inhibitor needed typically is significant, such as 25% and more typically 30 to 40% bw concentration is required. It would be beneficial for use in fracturing fluid applications if a combination of TGHI and LDHI could be used to prevent gas hydrate blockage, have reservoir compatibility, and have fracturing fluid properties and performance optimized for applications in deepwater extended reach or deep gas reservoir completions.

Suitable thermodynamic inhibitors include, but are not necessarily limited to, NaCl salt, KCl salt, CaCl₂ salt, MgCl₂ salt, NaBr₂ salt, formate brines (e.g. potassium formate), polyols (such as glucose, sucrose, fructose, maltose, lactose, gluconate, monoethylene glycol, diethylene glycol, triethylene glycol, mono-propylene glycol, dipropylene glycol, tripropylene glycols, tetrapropylene glycol, monobutylene glycol, dibutylene glycol, tributylene glycol, other polyglycols, glycerol, diglycerol, triglycerol, other polyglycerols, sugar alcohols (e.g. sorbitol, mannitol, and the like), methanol, propanol, ethanol, glycol ethers (such as diethyleneglycol monomethylether, ethyleneglycol monobutylether), alkyl or cyclic esters of alcohols (such as ethyl lactate, butyl lactate, methylethyl benzoate), other saccharides, glycols, solvents, alcohols, and electrolytes, and synergistic combinations and mixtures thereof. Graphs of pressure v. temperature gas hydrate phase equilibrium curves are predicted for various thermodynamic inhibitors taken singly and in combination are presented in FIGS. 16-24 demonstrating how these inhibitors and pairs of inhibitors would be expected to perform at the indicated concentrations.

Suitable kinetic and anti-agglomerate inhibitors include, but are not necessarily limited to, polymers and copolymers (such as INHIBEX® 101 and GAFFIX® 713 available from ISP Technologies), polysaccharides (such as hydroxy-ethylcellulose (HEC), carboxymethylcellulose (CMC), starch, starch derivatives, and xanthan), lactams (such as polyvinylcaprolactam, polyvinyl lactam), pyrrolidones (such as polyvinyl pyrrolidone of various molecular weights), surfactants (such as fatty acid salts, ethoxylated alcohols, propoxylated alcohols, sorbitan esters, ethoxylated sorbitan esters, polyglycerol esters of fatty acids, alkyl glucosides, alkyl polyglucosides, alkyl sulfates, alkyl sulfonates, alkyl ester sulfonates, alkyl aromatic sulfonates, alkyl betaine, alkyl amido betaines), hydrocarbon based dispersants (such as lignosulfonates, iminodisuccinates, polyaspartates), amino acids, proteins, and mixtures thereof.

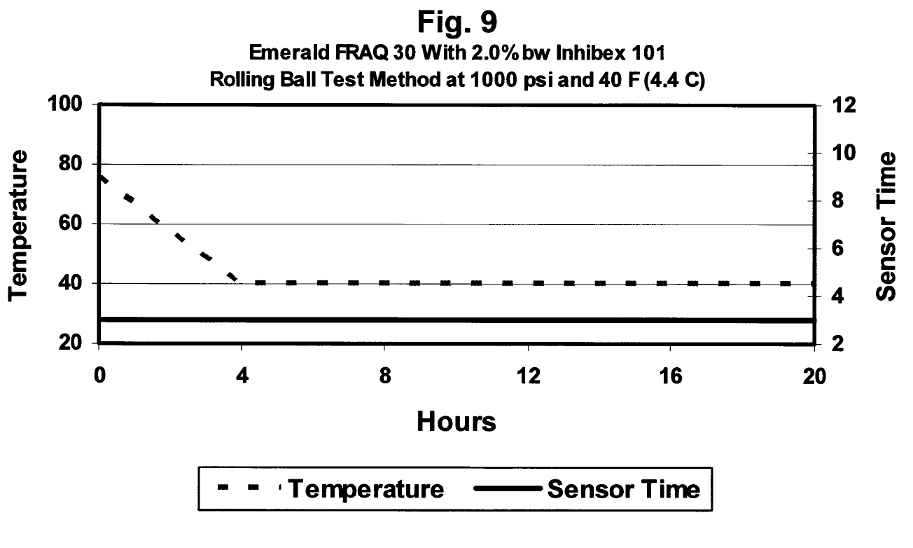

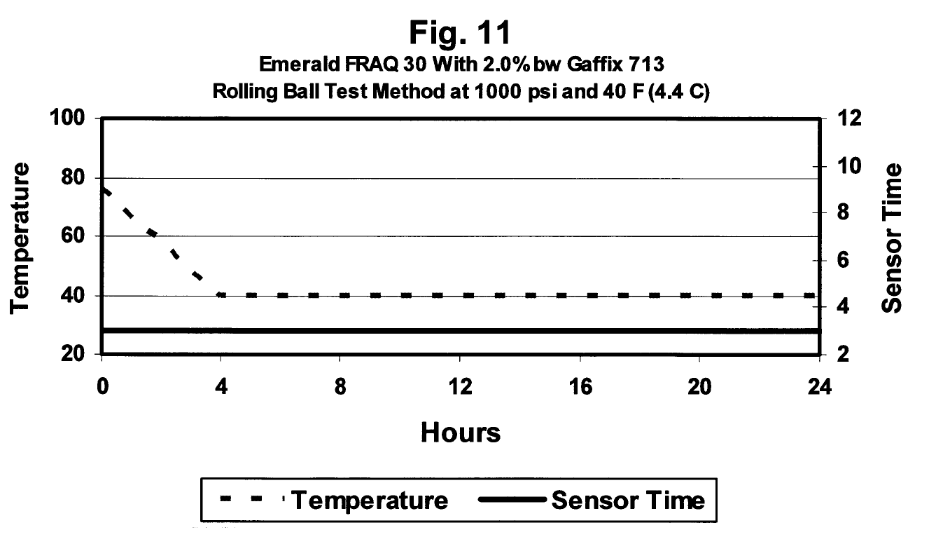

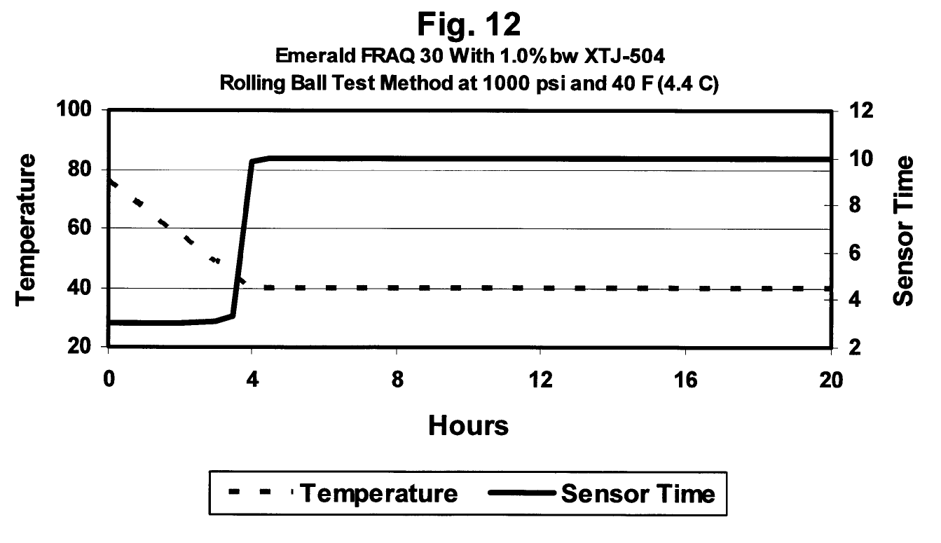

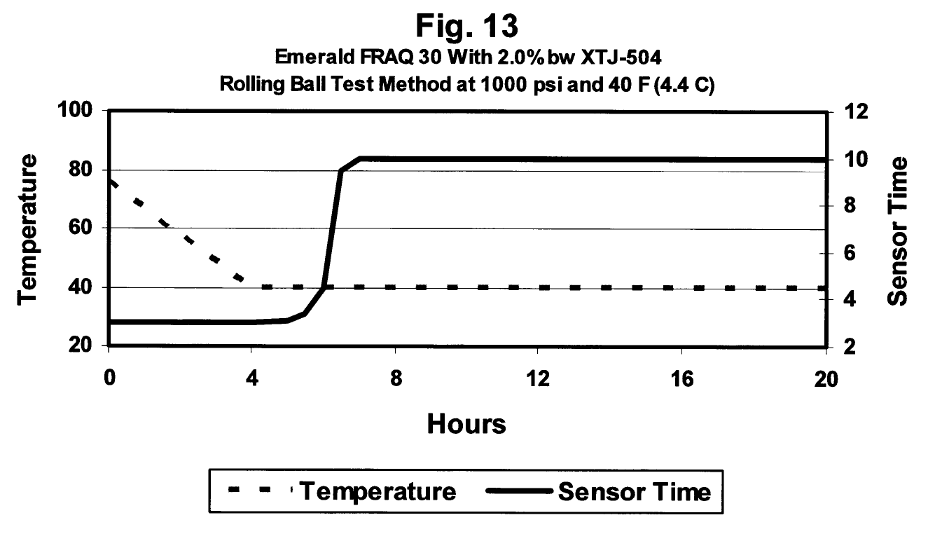

In one non-limiting embodiment, the gas hydrate inhibitors and the fracturing fluid compositions and methods herein have an absence of polyglycolpolyamines. The polyglycolpolyamine type LDHIs have been found and are presented herein to be very pressure sensitive. In particular, triethyleneglycoldiamine has been found to be more pressure sensitive than polymeric types of LDHI, as can been seen within FIGS. 7 through 15 herein. FIGS. 12 and 13 show 1.0% bw and 2.0% bw triethyleneglycoldiamine work very poorly when the pressure is a marginal 1000 psi (7 MPa) and the fluid temperature is at 40° F. (4.4° C.), whereas FIGS. 9 and 11 show 2.0% bw INHIBEX 101 and GAFFIX 713 provide gas hydrate prevention for more than 16 hours for the same set of pressure and temperature conditions. For this reason the polyglycolpolyamines are absent from this invention.

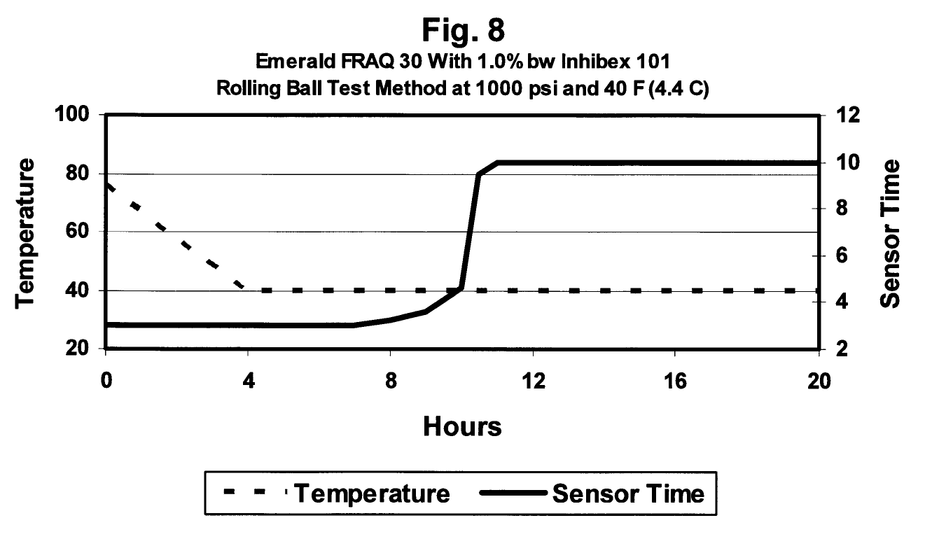

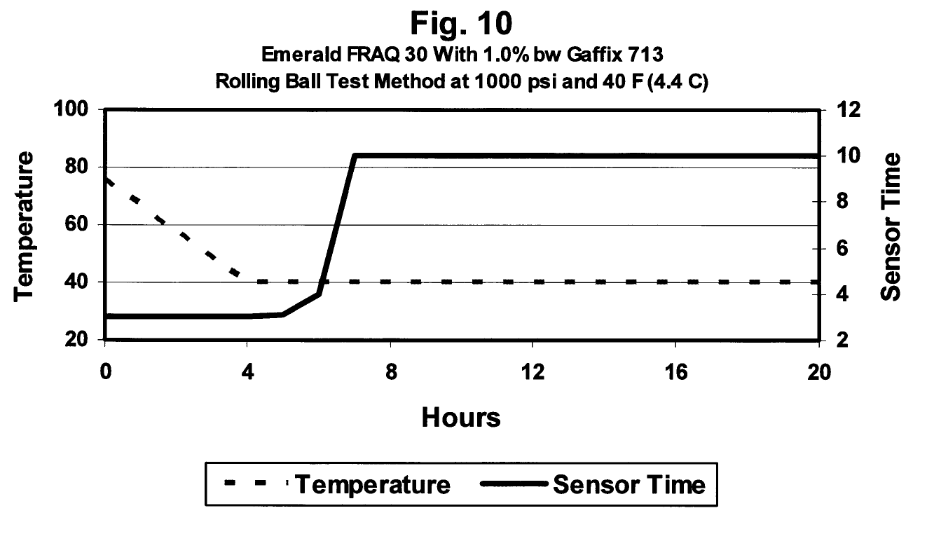

Additionally, the polyglycolpolyamines (e.g. triethyleneglycoldiamine) gas hydrate inhibitor art by Pakulski, et al. (see e.g. U.S. Pat. Nos. 6,331,508 and 6,756,345) teach that pressure is not an important variable if the simulated gas hydrate formation test procedure therein is used. This simulated test procedure uses a solution of 20% tetrahydrofuran (THF) in admixture with 3.5% bw NaCl salt in water with and without various LDHI then added, with the admixtures pumped at 0.05 to 0.1 ml/minute through tubing coil submersed and cooled within a cooling bath, with test pressures mentioned of “back pressure in the simulated pipeline”. How much back pressure (in psi, or MPa etc.) is not given. The tetrahydrofuran is a hydrocarbon, and does not take the proper place of relatively high pressure in testing gas hydrate inhibitors without tetrahydrofuran or crude oil type hydrocarbons present. When the LDHI, such as triethyleneglycoldiamine, is added to aqueous fluids (such as aqueous-based fracturing fluids) and then mixed with a typical reservoir gas (such as “Green Canyon” type gas composition as listed in Table 2), the polyglycolpolyamine type LDHI does not work past 3 hours at 40° F. (4.4° C.) with a relatively low test pressure of 1000 psi (7 MPa) (FIGS. 12 and 13). This lack of functionality at 1000 psi (7 MPa) without a crude oil type hydrocarbon phase present shows the polyglycoldiamines do not function as well as aqueous fracturing fluids which contain higher performing LDHI's, such as INHIBEX® 101 (FIGS. 8 and 9) and GAFFIX® 713 (FIGS. 10 and 11).

It is permissible that more than one type of gas hydrate inhibitor be used. In one non-limiting embodiment of the invention, at least two gas hydrate inhibitors are used in the fracturing fluid composition, one that would stay in solution phase and one that is a polymer and can become part of a polymer accumulation including, but not necessarily limited to, a filter cake or a proppant pack polymer accumulation typical of frac-pack treatments. The solution phase is important as a gas hydrate inhibitor that can be readily flowed back with reservoir fluids. The polymeric gas hydrate inhibitor can serve as a slower and more prolonged gas hydrate agent during well production. Because the polymeric gas hydrate inhibitor may be part of the filter cake and/or polymer accumulation/residue during and after the treatment, these inhibitors will be produced back over time during production, and lower molecular weight GHI polymers are used in one non-limiting embodiment, such as less than 1,000,000, and alternatively less than 50,000 molecular weight. Polymeric hydrate inhibitors in one non-restrictive embodiment are not used alone since a majority of the polymer will be trapped during the treatment, but the smaller the polymer size, the more readily it will flow back and be of utility as an anti-agglomerate inhibitor agent. An aqueous phase hydrate inhibitor is most important, and the polymeric inhibitor may be used as long as it is properly designed for plating out during a treatment. The thermodynamic inhibitors and the surfactants, and hydrocarbon dispersants could be the agents that would stay in solution. The polymers, copolymers, polysaccharides and proteins could be the agents that would become filtered at the formation face during fracturing operations and become filter cake and/or polymer accumulation within the proppant pack. As expected, it is preferred that the gas hydrate inhibitors be biodegradable or environmentally benign.

As further and more specifically defined within the context of this invention, “biodegradable” means the fracturing fluid systems containing gas hydrate inhibitors at typical concentrations will have over 30% and alternatively greater than 60% biodegradation within 28 days using in one non-limiting embodiment the OECD 306 test method (biodegradability in seawater —BOD closed bottle test method) or the OECD 301 D test method (biodegradability in fresh water —BOD closed bottle test method). “Environmentally benign” means the fracturing fluid system containing gas hydrate inhibitors has either an “Oil and Grease” content of less than 29.0 ppm HEM (hexane extractable material as per EPA Test Method 1664, Revision A) or has an aquatic toxicity of over 2,000 ppm and alternatively greater than 30,000 ppm to Mysid Shrimp (EPA Test Method 1007.0), or both. In one non-limiting embodiment, the fluid compositions herein have one or more of the environmental properties of (1) high biodegradability, (2) low oil and grease content, and/or (3) low toxicity to aquatic organisms. A fracturing fluid system containing TGHI and LDHI that passes one or more of these biodegradability, HEM, and toxicity specifications, and particularly all of them, will be of very low environmental impact to any environment, particularly marine environments, and is a major and significant improvement from current fracturing fluids even without gas hydrate inhibitors present.

The fracturing fluid composition of this invention can also incorporate additional components, such as pH buffers, biocides, surfactants, non-emulsifiers, anti-foamers, enzyme stabilizers, additional gel breakers such as saccharide breakers, oxidizer breakers and enzyme breakers, scale inhibitors, gel breaker aids, colorants, clay control agents, and mixtures thereof. In a preferred embodiment of the invention, these additional components are biodegradable. Biodegradable biocides include, but are not necessarily limited to, chlorhexidine gluconate, triclosan, sorbates, benzoates, propionates, parabens, nitrites, nitrates, bromides, bromates, chlorites, chlorates, hypochlorites, acetates, iodophors, hydroxyl methyl glycinate (INTEGRA® 44 from ISP Technologies), and mixtures thereof. Oxyalkyl polyols can be advantageously employed as non-emulsifiers and/or as water-wetting surfactants. Readily biodegradable non-emulsifier enhancers may include, but are not necessarily limited to, chelants such as polyaspartate, disodium hydroxyethyliminodiacetic (Na₂HEIDA), sodium gluconate; sodium glucoheptonate, glycerol, iminodisuccinates, and mixtures thereof.

Optionally, biodegradable colorants or dyes may be used in the fracturing fluid compositions of this invention to help identify them and distinguish them from other fluids used in hydrocarbon recovery.

Of course, a proppant is often used in fracturing fluids. Conventional proppants used in conventional proportions may be used with the fluid compositions and methods of this invention. Such conventional proppants include, but are not necessarily limited to, naturally occurring sand grains, man-made or specially engineered coated proppants (e.g. resin-coated sand or ceramic proppants), moderate to high-strength ceramic materials like ECONOPROP®, CARBOLITE®, CARBOPROP® proppants (all available from Carbo Ceramics) sintered bauxite, and mixtures thereof. Proppant materials are generally sorted for sphericity and size to give an efficient conduit for production of hydrocarbons from the reservoir to the wellbore.

It will be appreciated that it is difficult, if not impossible, to predict with specificity the proportions of the various components in the fracturing fluid compositions of this invention since any particular composition will depend upon a number of complex, interrelated factors including, but not necessarily limited to, the wellbore distance, the temperature differential or range over which the composition will be subjected, the expected pump rates and pressures for the fracturing operation, the particular hydratable polymer used, the particular crosslinking agent used, the particular gel breaker incorporated, the particular crosslink delay agent used, the particular gas hydrate inhibitor(s) employed, and the like.

The invention will now be further illustrated with respect to certain specific examples which are not intended to limit the invention, but rather to provide more specific embodiments as only a few of many possible embodiments.

### Example 1

One embodiment of the fluid composition of the invention for use in 5,000 feet (1,520 m) of deep water (total distance from the platform to the reservoir of 22,000 feet (6,700 m)) and 250° F. (121° C.) reservoir temperature may be as follows:
1. From about 30.0 to about 40.0 pptg (about 3.6 to about 4.8 kg/m³) fracturing polymers and crosslinker, in one non-limiting embodiment preferably a borate crosslinked guar.
2. From about 0.5 to about 1.0 gptg sodium glucoheptonate and 1.0 to about 2.0 gptg XL-2LW borate mineral crosslinkers. For effective crosslink delay in 5,000 feet (1,520 m) of water and 22,000 feet (6,700 m) total depth to the formation:

a) About 0.6 gptg sodium glucoheptonate, and

b) About 1.25 gptg XL-2LW for 250° F. (121° C.) formation temperature.
3. From about 2.5 to about 3.0 gptg BA-5 pH buffer for crosslinking borate ions.
4. From about 0.1 to about 0.25 gptg INTEGRA 44 available from ISP technologies for biocide.
6. From about 1.0 to about 2.0 pptg (about 0.12 to about 0.24 kg/m³) AG-6206 water wetting surfactant product available from Akzo Nobel.
7. About 2.0 gptg NE-200E non-emulsifier, scale inhibitor, and crosslink delay agent from Baker Oil Tools.
8. About 2.0% by weight (bw) KCl clay control agent.
9. From about 2.0 to 10.0 pptg (about 0.24 to about 1.20 kg/m³) DBW-202E (encapsulated lactose polysaccharide polymer breaker and thermodynamic gas hydrate inhibitor from Baker Oil Tools) as gel breaker.
10. To prevent gas hydrate formation:

a) About 20.0% bw NaCl, and

b) About 145.0 gptg (about 15.0% bw) ethylene glycol, and

c) About 5.0 gptg INHIBEX 101 available from ISP Technologies.
12. 0 to 14 ppg proppant (pounds proppant added per 1.0 fluid gallon volume) (0 to 1.7 kg/l).

### Example 2

Another non-limiting embodiment of the fluid composition of the invention for use in 1,000 feet (305 m) of deep water (total distance from the platform to the reservoir of 8,000 feet or 2438 m) and 150° F. (65° C.) reservoir temperature may be as follows:
1. From about 20.0 to about 30.0 pptg (about 2.4 to about 3.6 kg/m³) fracturing polymers and crosslinker, in one non-limiting embodiment preferably a borate crosslinked guar.
2. For effective crosslink delay in 1,000 feet (305 m) of water and 8,000 feet (2,438 m) total depth to the formation:
   a) About 0.5 gptg XL-3L for cool water crosslink delay, and
   b) About 0.4 gptg XL-2LW for 150° F. (65° C.) formation temperature that the fracturing fluid will heat up to.
3. From about 0.75 to about 1.0 gptg BA-5 pH buffer for crosslinking borate ions.
4. From about 1.0 to about 2.0 gptg AG-6206 (from Akzo Nobel), water wetting agent surfactant and about 2.0 gptg NE-200E non-emulsifier, scale inhibitor, and crosslink delay agent from Baker Oil Tools
5. From about 2.0 to about 5.0% bw KCl clay control agent.
6. From about 0.005 to about 0.01 gptg 12.0% bw sodium hypochlorite solution for biocide.
7. From about 0.5 to about 2.0 gptg A-5D scale inhibitor, gas hydrate inhibitors, and non-emulsifier aids from Flexible Solutions International.
8. From about 2.0 to 6.0 gptg GBW-201 LE saccharide-based gel breaker and 4.0 pptg DBW-1 (0.48 kg/m³) encapsulated ammonium persulfate gel breakers from Baker Oil Tools.
10. To prevent gas hydrate formation:
   a) About 20.0% bw NaCl, and
   b) About 88.5 gptg (about 10.0% bw) glycerol, and
   b) About 20.0 pptg (2.4 kg/m³) polyvinyl pyrrolidone K-30 available from ISP Technologies.
11. 0 to 14 ppg proppant (pounds proppant added per 1.0 fluid gallon volume) (0 to 1.7 kg/l).

### Example 3

Another non-limiting embodiment of the fluid composition of the invention for use in 10,000 feet (3040 m) of deep water (total distance from the platform to the reservoir of 25,000 feet or 7600 m) and 200° F. (93° C.) reservoir temperature may be as follows:
1. About 30.0 pptg (about 3.6 kg/m³) guar fracturing polymers.
2. For effective crosslink delay in 10,000 feet (3040 m) of water and 25,000 feet (7600 m) total depth to the formation:
   a) About 0.6 gptg XL-2LW for 200° F. (93° C.) formation temperature that the fracturing fluid will heat up to.
3. About 3.0 gptg BA-5 pH buffer for crosslinking borate ions.
4. About 1.0 gptg AG-6206 alkyl glucoside (from Akzo Nobel) water wetting surfactant.
5. About 2.0 bw KCl and about 2.0 gptg Claprotek CF (choline bicarbonate available from CESI Chemicals) clay control agent.
6. From about 0.1 to about 0.25 gptg Integra 44 biocide.
7. About 5.0 gptg NE-200E non-emulsifier, scale inhibitor, and crosslink delay agent from Baker Oil Tools.
8. From about 0.5 to 2.0 gptg GBW-201 LE and 10.0 pptg DBW-202E (1.20 kg/m³) from Baker Oil Tools as gel breakers.
9. To prevent gas hydrate formation:
   a) About 5.0 gptg UNIQEMA TWEEN 20 (POE (20) sorbitan monolaurate), and
   b) About 5.0 gptg—INHIBEX 101 available from ISP Technologies, and
   c) About 194.0 gptg (about 20.0% bw) ethylene glycol, and
   d) About 20.0% bw NaCl
10. From 0 to 14 ppg proppant (0 to 1.7 kg/l).

In the foregoing specification, the invention has been described with reference to specific embodiments thereof, and is expected to be demonstrated as effective in fracturing subterranean formations in deep water completion operations. The components and combinations discussed would be expected to work in commercial fracturing fluids. However, it will be evident that various modifications and changes can be made to the fracturing fluid compositions without departing from the broader spirit or scope of the invention as set forth in the appended claims. Accordingly, the specification is to be regarded in an illustrative rather than a restrictive sense. For example, specific combinations of or proportions of components falling within the claimed parameters, but not specifically identified or tried in particular compositions, are anticipated and expected to be within the scope of this invention.

I claim:

1. A fracturing fluid composition comprising:
i) water;
ii) at least one hydratable polymer;
iii) at least one crosslinking agent;
iv) at least one crosslinking delay agent;
v) at least one breaking agent; and
vi) at least one gas hydrate inhibitor in the absence of polyglycolpolyamines, where the gas hydrate inhibitor is selected from the group consisting of:
thermodynamic inhibitors selected from the group consisting of NaCl salt, KCl salt, CaCl₂ salt, MgCl₂ salt, NaBr₂ salt, formate brines, polyols, glycols, glycerols, alkyl and cyclic esters of alcohols, saccharides, solvents, alcohols, sugar alcohols, and electrolytes,
kinetic and anti-agglomerate inhibitors selected from the group consisting of polysaccharides, pyrrolidones, fatty acid salts, ethoxylated alcohols, propoxylated alcohols, alkyl glucosides, alkyl polyglucosides, alkyl sulfates, alkyl sulfonates, alkyl aromatic sulfonates, sorbitan esters, ethoxylated sorbitan esters, polyglycerol esters of fatty acids, alkyl betaines, alkyl amino betaines, amino acids, proteins, iminodisuccinates, polyaspartates, and
mixtures thereof;
where the fracturing fluid composition is biodegradable and environmentally benign, and where the fracturing fluid composition does not form gas hydrates at pressures between about 1000 to about 10,000 psi (about 6.9 to about 69 MPa) and temperatures below about 45° F. for at least 24 hours.

2. The fracturing fluid composition of claim 1 further comprising:
vii) an additional gas hydrate inhibitor different from vi);
where one of the gas hydrate inhibitors remains in the aqueous phase and the other gas hydrate inhibitor is a polymer that at least temporarily becomes part of a polymer accumulation.

3. The fracturing fluid composition of claim 1 where the crosslinking delay agent can function over a temperature range from about 300° to about 30° F. (about 149° to about −1° C.).

4. The fracturing fluid composition of claim 1 where the crosslinking agent iii) and the crosslinking delay agent iv) is a single component.

5. The fracturing fluid composition of claim 4 where the single component is selected from the group consisting of slurried borax suspensions, ulexite, colemanite; complexes of borate ion, zirconate ion and/or titanate ion with a polyol selected from the group of sorbitol, mannitol, sodium gluconate, sodium glucoheptonate, glycerol, alpha D-glucose, fructose, ribose, alkyl glucosides, and mixtures thereof.

6. The fracturing fluid composition of claim 1 where the hydratable polymer is a polysaccharide.

7. The fracturing fluid composition of claim 6 where the hydratable polymer is selected from the group consisting of guar, hydroxypropyl guar, carboxymethylhydroxypropyl guar, and other guar polymer derivatives.

8. The fracturing fluid composition of claim 1 further comprising:
viii) an additional crosslinking delay agent different from iv).

9. The fracturing fluid composition of claim 1 where the crosslinking agent is selected from the group consisting of titanate ion, zirconate ion, borate ion, and mixtures thereof.

10. The fracturing fluid composition of claim 1 where the breaking agent is selected from the group consisting of saccharide breakers, enzyme breakers, oxidizer breakers, and mixtures thereof.

11. The fracturing fluid composition of claim 1 further comprising:
from about 10 to about 60 pptg (about 1.2 to about 7.2 kg/m³) of hydratable polymer;
from about 0.025 to about 3.0 volume % of crosslinking and delaying agent;
from about 0.006 to about 0.5 bw % of crosslinking delay agent;
from about 0.1 to about 40.0 pptg (about 0.072 to about 4.8 kg/m³) of breaking agent; and
from about 0.006 to about 60 bw % of gas hydrate inhibitor.

12. A method for fracturing a subterranean formation comprising:
a. pumping a fracturing fluid composition down a wellbore to a subterranean formation;
b. permitting the fracturing fluid composition to gel;
c. pumping the fracturing fluid composition against the subterranean formation at sufficient rate and pressure to fracture the formation;
d. breaking the fracturing fluid composition gel;
e. subsequently flowing the fracturing fluid composition out of the formation;
where the fracturing fluid composition comprises:
i) water;
ii) at least one hydratable polymer;
iii) at least one crosslinking agent;
iv) at least one crosslinking delay agent;
v) at least one breaking agent; and
vi) at least one gas hydrate inhibitor in the absence of polyglycolpolyamines, where the gas hydrate inhibitor is selected from the group consisting of:
thermodynamic inhibitors selected from the group consisting of NaCl salt, KCl salt, CaCl₂ salt, MgCl₂ salt, NaBr₂ salt, formate brines, polyols, glycols, glycerols, alkyl and cyclic esters of alcohols, saccharides, solvents, alcohols, sugar alcohols, and electrolytes,
kinetic and anti-agglomerate inhibitors selected from the group consisting of polysaccharides, pyrrolidones, fatty acid salts, ethoxylated alcohols, propoxylated alcohols, alkyl glucosides, alkyl polyglucosides, alkyl sulfates, alkyl sulfonates, alkyl aromatic sulfonates, sorbitan esters, ethoxylated sorbitan esters, polyglycerol esters of fatty acids, alkyl betaines, alkyl amino betaines, amino acids, proteins, iminodisuccinates, polyaspartates, and
mixtures thereof;
where the fracturing fluid composition is biodegradable and environmentally benign, and where the fracturing fluid composition does not form gas hydrates at pressures between about 1000 to about 10,000 psi (about 6.9 to about 69 MPa) and temperatures below about 45° F. for at least 24 hours.

13. The method of claim 12 where at least part of the wellbore extends from an offshore platform to a sea floor where the distance from the offshore platform to the sea floor is at least 1,000 feet (304 m), and where the temperature differential over the length of the wellbore from the sea floor to the subterranean formation is at least about 90° F. (50° C.).

14. The method of claim 12 where in the fracturing fluid composition, the composition further comprises:
vii) an additional gas hydrate inhibitor different from vi);
where one of the gas hydrate inhibitors remains in the aqueous phase and the other gas hydrate inhibitor is a polymer that at least temporarily becomes part of a polymer accumulation.

15. The method of claim 12 where in the fracturing fluid composition the crosslinking delay agent can function over a temperature range from about 350° to about 25° F. (about 177° to about −4.0° C.).

16. The method of claim 12 where in the fracturing fluid composition the crosslinking agent iii) and the crosslinking delay agent iv) is a single component.

17. The method of claim 16 where in the fracturing fluid composition the single component is selected from the group consisting of slurried borax suspensions, ulexite, colemanite, complexes of borate ion, zirconate ion and/or titanate ion with a polyol selected from the group of sorbitol, mannitol, sodium gluconate, sodium glucoheptonate, glycerol, alpha D-glucose, fructose, ribose, alkyl glucosides, and mixtures thereof.

18. The method of claim 12 where the hydratable polymer is selected from the group consisting of a guar, hydroxypropyl guar, carboxymethylhydroxypropyl guar, and other guar polymer derivatives.

19. The method of claim 12 where the fracturing fluid further comprising:
from about 10 to about 60 pptg (about 1.2 to about 7.2 kg/m³) of hydratable polymer;
from about 0.025 to about 3.0 volume % of crosslinking agent;
from about 0.006 to about 0.5 bw % of crosslinking delay agent;
from about 0.1 to about 40.0 pptg (about 0.072 to about 4.8 kg/m³) of breaking agent; and
from about 0.006 to about 60 bw % of gas hydrate inhibitor.

20. A method for fracturing a subterranean formation comprising:
a. pumping a fracturing fluid composition down a wellbore to a subterranean formation, where the temperature differential over the length of the wellbore is at least about 90° F. (50° C.);
b. permitting the fracturing fluid composition to gel;
c. pumping the fracturing fluid composition against the subterranean formation at sufficient rate and pressure to fracture the formation;
d. breaking the fracturing fluid composition gel;
e. subsequently flowing the fracturing fluid composition out of the formation;
where the fracturing fluid composition comprises:
i) water;
ii) at least one hydratable polymer;
iii) at least one crosslinking agent, where the crosslinking delay agent can function over a temperature range from about 350° F. to about 25° F. (173° C. to about −4.0° C.);
iv) at least one crosslinking delay agent;
v) at least one breaking agent; and
vi) at least one gas hydrate inhibitor in the absence of polyglycolpolyamines, where the gas hydrate inhibitor is selected from the group consisting of:
thermodynamic inhibitors selected from the group consisting of NaCl salt, KCl salt, CaCl₂ salt, MgCl₂ salt, NaBr₂ salt, formate brines, polyols, glycols, glycerols, alkyl and cyclic esters of alcohols, saccharides, solvents, alcohols, sugar alcohols, and electrolytes,
kinetic and anti-agglomerate inhibitors selected from the group consisting of polysaccharides, pyrrolidones, fatty acid salts, ethoxylated alcohols, propoxylated alcohols, alkyl glucosides, alkyl polyglucosides, alkyl sulfates, alkyl sulfonates, alkyl aromatic sulfonates, sorbitan esters, ethoxylated sorbitan esters, polyglycerol esters of fatty acids, alkyl betaines, alkyl amino betaines, amino acids, proteins, iminodisuccinates, polyaspartates, and
mixtures thereof;
where the fracturing fluid composition is biodegradable and environmentally benign, and where the fracturing fluid composition does not form gas hydrates at pressures between about 1000 to about 10,000 psi (about 6.9 to about 69 MPa) and temperatures below about 45° F. for at least 24 hours.
